(19) United States
(12) Patent Application Publication
(10) Pub. No.: US 2026/0161599 A1
(43) Pub. Date: Jun. 11, 2026

(54) METHOD AND DEVICE FOR CONVERTING FILES

(71) Applicants: HYUNDAI MOTOR COMPANY, Seoul (KR); KIA CORPORATION, Seoul (KR)

(72) Inventors: Woo Sung Lee, Hwaseong-si (KR); Yonghee Lee, Hwaseong-si (KR)

(73) Assignees: HYUNDAI MOTOR COMPANY, Seoul (KR); KIA CORPORATION, Seoul (KR)

(21) Appl. No.: 19/392,127

(22) Filed: Nov. 17, 2025

(30) Foreign Application Priority Data
Dec. 6, 2024 (KR) 10-2024-0180515

(51) Int. Cl. G06F 16/11; H04L 12/40; H04L 67/12; H04L 67/565

(52) U.S. Cl. CPC G06F 16/116; H04L 12/40; H04L 67/12; H04L 67/565; H04L 2012/40215; H04L 2012/40273

(57) ABSTRACT

A file conversion method may include receiving a first type controller area network (CAN) database container (DBC) file. The method may further include generating a first data frame including a signal name, a message name and a message identifier as information from the first type CAN DBC file. The method may further include converting the message name and the message identifier from the first data frame into a second data frame by regenerating the message name and the message identifier according to a predetermined rule. The method may further include generating a second type CAN DBC file from the second data frame.

### CROSS-REFERENCE TO RELATED APPLICATION

This application claims the priority to and the benefit of Korean Patent Application No. 10-2024-0180515 filed with the Korean Intellectual Property Office on Dec. 6, 2024, the entire contents of which are incorporated herein by reference.

### TECHNICAL FIELD

The present disclosure relates to a method and a device for a file conversion, particularly involving a controller area network (CAN)-related data.

### BACKGROUND

The development of a purpose built vehicle (PBV) has brought about a major change in an automobile industry, and an external platform of a vehicle on which it is mounted is designed to perform specific functions depending on the purpose. At the heart of this technology ecosystem, a Controller Area Network (CAN) bus enables an efficient data exchange between various electronic control units (ECUs) within the vehicle and external platforms. As the PBV vehicles are designed for a variety of purposes and the complexity and volume of the data required increases, the gateway role of the CAN bus becomes increasingly important. However, a database container (DBC) automatic creation system for the efficient use of the gateway has not currently been established.

Previously, there was no system to automatically convert or generate the vehicle CAN DB, which caused various problems. First, it takes a lot of time to create the CAN DB. Currently, the CAN DB using a tool provided by a VECTOR must be manually edited, which takes at least 2 hours and up to 8 hours or more. Second, human errors that occur during the manual editing of the CAN DB may lead to DB errors, which in turn increases the risk of rework and time loss. Third, the data lacks flexibility. The editing and monitoring in the VECTOR tools are limited to a specific format, which does not guarantee a compatibility with other formats, and there is limited flexibility in converting or saving to data formats required by external platforms. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure aims to provide a method and a device for a file conversion that may provide a library automatically generating a gateway DBC for an efficient routing of the CAN data between the vehicle and the external platform.

A file conversion method according to an embodiment performed by a computing device including a processor includes receiving, by the processor, a first type controller area network (CAN) database container (DBC) file. The method further includes generating, by the processor, a first data frame including a signal name, a message name and a message identifier as information from the first type CAN DBC file. The method further includes converting, by the processor, the message name and the message identifier from the first data frame into a second data frame by regenerating the message name and the message identifier according to predetermined rules. The method further includes generating, by the processor, a second type CAN DBC file from the second data frame.

In some embodiments, converting, by the processor, the message name and the message identifier from the first data frame into the second data frame may include sorting, by the processor, the message identifier in the first data frame in an ascending order; and generating, by the processor, the message identifier as a different value in the ascending sorted state.

In some embodiments, generating the message identifier may include generating and allocating, by the processor, one message identifier for one message when the type of the message belonging to the first data frame is a High-Speed CAN (HS CAN).

In some embodiments, generating the message identifier may include generating and allocating, by the processor, a plurality of sequentially increasing message identifiers for one message when the type of the message belonging to the first data frame is a CAN with Flexible Data-Rate (CAN FD).

In some embodiments, the first data frame may further include a start bit. Converting, by the processor, the message name and the message identifier from the first data frame into the second data frame may further include generating and assigning, by the processor, the start bit to a value different from that of the first data frame.

In some embodiments, converting the second data frame may further include, after the message name is generated with a different value, adding, by the processor, an identification character that is set differently for each vehicle to the generated message name.

In some embodiments, when a message is added, the message name of the added message may remain the same and the other values may be changed.

In some embodiments, the message identifier may include alphabets and hexadecimal numbers.

In some embodiments, the method may further include transmitting, by the processor, the second type CAN DBC file to an external platform.

In some embodiments, generating the second type CAN DBC file may include generating, by the processor, a plurality of second type CAN DBC files by dividing the second data frame for each recipient recorded in the second data frame.

A file conversion device according to an embodiment may include at least one non-transitory computer-readable media configured to instructions; and at least one processor. The at least one processor is configured, by executing the instructions, to receive a first type controller area network (CAN) database container (DBC) file. The at least one processor is further configured to generate a first data frame including a signal name, a message name and a message identifier as information from the first type CAN DBC file. The at least one processor is further configured to convert the message name and the message identifier from the first data frame into a second data frame by regenerating the message name and the message identifier according to predetermined rules. The at least one processor is further configured to generate a second type CAN DBC file from the second data frame,

In some embodiments the at least one processor is further configured to sort the message identifier in the first data frame in an ascending order; and generate the message identifier as a different value in the ascending sorted state.

In some embodiments, the at least one processor is further configured to generate and allocate one message identifier for one message when the type of the message belonging to the first data frame is a High-Speed CAN (HS CAN).

In some embodiments, the at least one processor is further configured to generate and allocate a plurality of sequentially increasing message identifiers for one message when the type of the message belonging to the first data frame is a CAN with Flexible Data-Rate (CAN FD).

In some embodiments, the first data frame may further include a start bit. The at least one processor is further configured to generate and assign the start bit to a value different from that of the first data frame.

In some embodiments, the at least one processor is further configured to, after the message name is generated with a different value, add an identification character that is set differently for each vehicle to the generated message name.

In some embodiments, when a message is added, the message name of the added message may remain the same and the other values may be changed.

In some embodiments, the message identifier may include alphabets and hexadecimal numbers.

In some embodiments, the at least one processor is further configured to generate a plurality of second type CAN DBC files by dividing the second data frame for each recipient recorded in the second data frame.

The present disclosure further provides a non-transitory computer-readable media configured to store instructions that, when executable by at least one processor of a computing device, cause the computing device to perform operations comprising: receiving a first type controller area network (CAN) database container (DBC) file; generating a first data frame including a signal name, a message name and a message identifier as information from the first type CAN DBC file; converting the message name and the message identifier from the first data frame into a second data frame by regenerating the message name and the message identifier according to predetermined rules; and generating a second type CAN DBC file from the second data frame.

### BRIEF DESCRIPTION OF THE DRAWINGS

FIG. 1 is a view for explaining a file conversion device according to one embodiment.

FIG. 2-FIG. 4 are views for explaining an operation of a file conversion device according to one embodiment.

FIG. 5 is a view for explaining a file conversion method according to one embodiment.

FIG. 6-FIG. 14 are views for explaining an operation of a file conversion device according to one embodiment.

FIG. 15 is a view for explaining a computing device according to one embodiment.

The drawings described herein are for illustration purposes only and are not intended to limit the scope of the present disclosure in any way.

### DETAILED DESCRIPTION

Hereinafter, the present disclosure is described more fully hereinafter with reference to the accompanying drawings, in which embodiments of the present disclosure are shown. As those having ordinary skill in the art should realize, the described embodiments may be modified in various different ways, all without departing from the spirit or scope of the present disclosure. Accordingly, the drawings and description should be regarded as illustrative in nature and not restrictive. Like reference numerals designate like elements throughout the specification.

In addition, unless explicitly described to the contrary, the term “comprise” and variations such as “comprises” or “comprising”, should be understood to include stated elements rather than exclude any other elements. Terms including ordinal numbers such as first, second, and the like are used only to describe various components and should not be interpreted as limiting these components. The terms are only used to differentiate one component from other components.

Terms “-er”, “-or”, and “module” described in the present disclosure mean units for processing at least one function and operation and can be implemented by hardware components or software components and combinations thereof. In addition, at least some of configurations or functions of file conversion methods and devices according to embodiments described below may be implemented as a program or software, and the program or software may be stored in a computer-readable recording medium or storage medium. When a controller, “-er”, “-or”, module, component, device, element, or the like of the present disclosure is described as having a purpose or performing an operation, function, or the like, the controller, “-er”, “-or”, module, component, device, element, or the like should be considered herein as being “configured to” meet that purpose or to perform that operation or function. Each controller, “-er”, “-or”, module, component, device, element, and the like may separately embody or be included with a processor and a memory, such as a non-transitory computer readable media, as part of the apparatus.

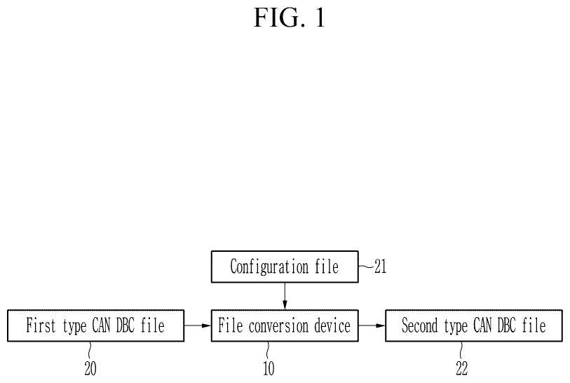

FIG. 1 is a view for explaining a file conversion device according to one embodiment.

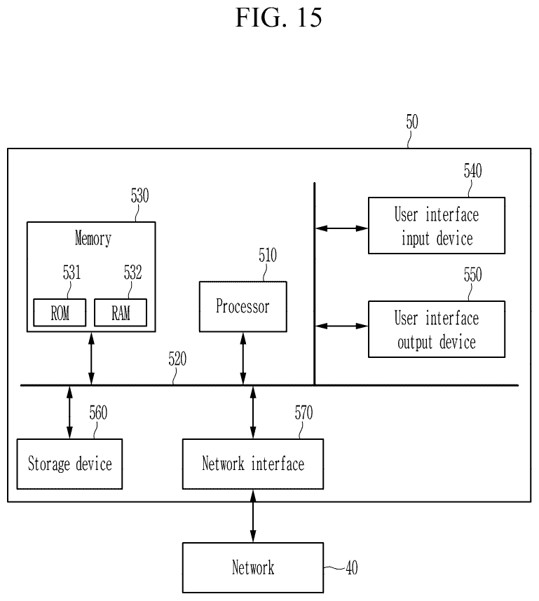

Referring to FIG. 1, a file conversion device 10 according to one embodiment may be implemented as a computing device including a processor and a memory. For example, a connecting device a vehicle and an external device may be implemented as a computing device 50 as described below with reference to FIG. 15. In this case, the processor may correspond to the processor 510 of the computing device 50, and the memory may correspond to the memory 520 of the computing device 50. Alternatively, in some embodiments, the file conversion device 10 may include one or more non-transitory computer-readable media including instructions and one or more processors for executing the instructions to perform operations. Here, the operation may include the configuration, function, step, etc. described in the present disclosure for the file conversion method and device according to the embodiments. In the present disclosure, the term “module” is used to logically distinguish these operations performed by the file conversion method and device according to the embodiments.

The processing for automatic database container (DBC) generation performed by the file conversion device 10 may be performed as follows. First, a signal information to be extracted from a conventional DBC may be input in an YAML or Excel file format. The signal information to be extracted from the conventional DBC may include a controller area network (CAN) device name, a message name, a signal name, a receiving controller, etc. The file conversion device 10 may read the DBC file as a text and extract a BO_ (a message), a SG_ (a signal), a BA_ (an item), a VAL_ (a signal value), etc. by comparing them line by line. For the extracted signal information, the message name, a transmission and receiver, an ID, etc. defined in the input are newly assigned or changed. All changed signal information may be stored in a new DBC file, and signals with the same message name may be reclassified and merged to reconfigure the start bit to fit the DBC syntax to avoid data waste and collisions. All data is framed and can be converted and stored per a receiver to suit the needs of external platforms. Below, the details of the file conversion device 10 are described below.

The file conversion device 10 may receive a first type CAN DBC file 20 and a configuration file 21 and output a second type CAN DBC file 22. Here, the first type CAN DBC file 20 may be, for example, a CAN DBC file that is difficult to leak to the outside, and the second type CAN DBC file 22 may be, for example, a CAN DBC file that can be leaked to the outside. The configuration file 21 may include the information about the CAN equipment name, the path of the first type of CAN DBC file 20, the message name, the signal name, and the receiver.

In some embodiments, the configuration file 21 may include a plurality of CAN equipment names

In this case, in the configuration file 21, the information about the path of the first type of CAN DBC file 20, the message name, the signal name, and the receiver may be stored in a grouped format for each of the plurality of CAN equipment names.

The file conversion device 10 may extract the signal name by parsing the configuration file 21 and may extract a line corresponding to the signal name extracted from the configuration file 21 from the first type CAN DBC file 20.

In some embodiments, the file conversion device 10 may sequentially read the first type CAN DBC file 20 in one direction. The file conversion device 10 may determine whether the first line being read includes the signal name. If the first line includes a signal name, the file conversion device 10 may extract the corresponding line. Additionally, the file conversion device 10 may read the first type CAN DBC file 20 in one direction. The file conversion device 10 may determine whether the signal name is included in the second line being read after the first line. If the second line includes the signal name, the file conversion device 10 may extract the corresponding line.

In some embodiments, the file conversion device 10 may extract a BO line, a CM line, a BA lines, and a BAL line corresponding to the signal name from the first type CAN DBC file 20 when extracting the line corresponding to the signal name extracted from the configuration file 21.

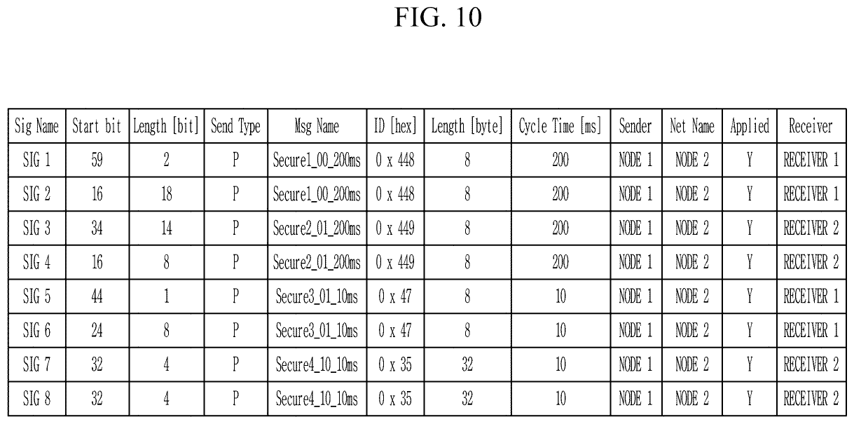

The file conversion device 10 may generate a first data frame by configuring the information included in the extracted line according to a second type format different from the first type. Here, the first data frame may correspond to an existing signal data frame as illustrated in FIG. 10.

In some embodiments, the file conversion device 10 may load the information included in the first line and the information included in the second line into memory. The file conversion device 10 can analyze the information included in the first line and the information included in the second line according to a predetermined message frame and signal format. The file conversion device 10 can extract information about the signal name, the start bit, the signal size, the message type, the message name, an identifier, a message size, a cycle, a transmitter, a net name, whether a standardization is applied, and a receiver. The file conversion device 10 may generate a first data frame to include the extracted information.

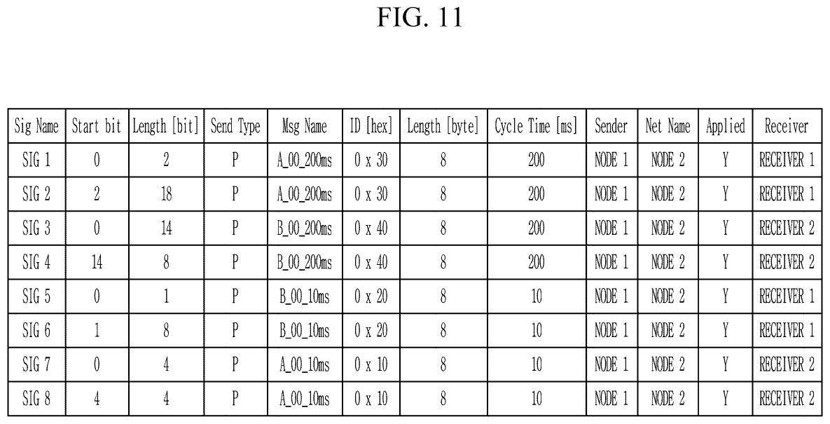

The file conversion device 10 may generate a second data frame by converting the values of some items in the first data frame into a different format. Here, the second data frame may correspond to a security signal data frame as illustrated in FIG. 11.

In some embodiments, the file conversion device 10 may, when generating the second data frame, read the message size from the first data frame and change the value of the message size to another value depending on the protocol to be changed. Additionally, the file conversion device 10 may reallocate the start bits considering the signal size. In addition, the file conversion device 10 may group the message by each cycle and change the message name of the message grouped for each cycle. Additionally, the file conversion device may 10 may group the message for each identifier, sort them for the identifier, and change the identifier for the sorted list.

The file conversion device 10 may generate a second type CAN DBC file 22 from the second data frame.

In some embodiments, the file conversion device 10 may generate a plurality of second type CAN DBC files by dividing the second data frame for each receiver.

Particularly, the file conversion device 10 may receive the first type CAN DBC file 20, may generate the first data frame including the signal name, the message name and the message identifier as information from the first type CAN DBC file 20, may regenerate the message name and the message identifier from the first data frame according to a predetermined rule to be converted into the second data frame, and then may generate the second type CAN DBC file from the second data frame.

In some embodiments, the file conversion device 10 may sort the message identifier in the first data frame in an ascending order and may generate the message identifier with different values while in the ascending order. The file conversion device 10 may generate and assign one message identifier for one message when the type of message belonging to the first data frame is a High-Speed CAN (HS CAN). In contrast, if the type of the message belonging to the first data frame is a CAN with Flexible Data-Rate (CAN FD), the file conversion device 10 may generate and assign a plurality of message identifiers that sequentially increase for one message.

In some embodiments, the first data frame further includes a start bit, and the file conversion device 10 may convert it into the second data frame by generating and assigning the start bit to a different value than that of the first data frame.

In some embodiments, the file conversion device 10 may convert the message name into the second data frame by adding an identification character that is set differently for each vehicle to the generated message name after the message name is generated with the other value.

In some embodiments, when the message is added, in the message name of the added message, the identification character may remain the same and the other values may be changed.

In some embodiments, the message identifier may include alphabetic and hexadecimal characters.

In some embodiments, the file conversion device 10 may transmit the second type CAN DBC file to an external platform.

In some embodiments, the file conversion device 10 may generate a plurality of second type CAN DBC files by dividing the second data frame for each recipient recorded in the second data frame.

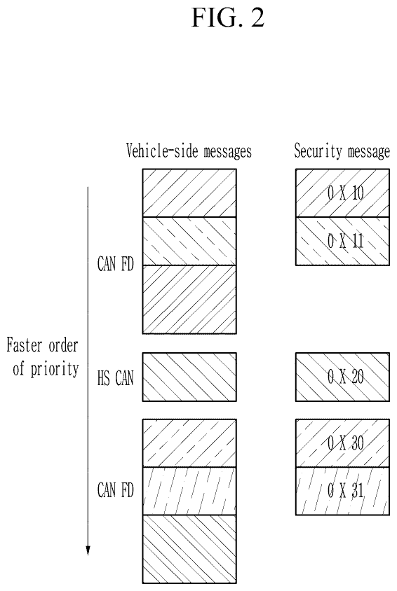

FIGS. 2-4 are views for explaining an operation of a file conversion device according to one embodiment.

Referring to FIG. 2, in a case of a message ID, because a lower message ID has a higher priority due to the characteristic of the CAN, if the priority-based reset is not performed in the process of converting the vehicle message to a security message, there is a risk that the communication delay time between the vehicle and the external platform is long. To prevent this, the necessary vehicle messages is listed in an ID order, then the security message ID is set in that order. Additionally, a process of changing the start bit for each message is required to enhance the security.

For example, when a previous vehicle message (a mix of the CAN FD and the HS CAN) is converted into the secure message (HS CAN), the message ID encryption may be done through the following process:

First, the vehicle-side messages are listed in order of the priority (the lower message ID order). Next, the usage signal changes the security message ID to 0x10, 0x20, 0x30, etc. in that order. In this process, if the vehicle-side message is long as FD, the last digit of the ID is increased and set to 0x10, 0x11, 0x12, etc. when converted to the security message HS. On the other hand, if the vehicle side message is HS, the length is the same so the ID is kept as is. Finally, the security of the vehicle message may be enhanced by randomly rearranging the start bit of each signal within the security message to be different from the vehicle-side message.

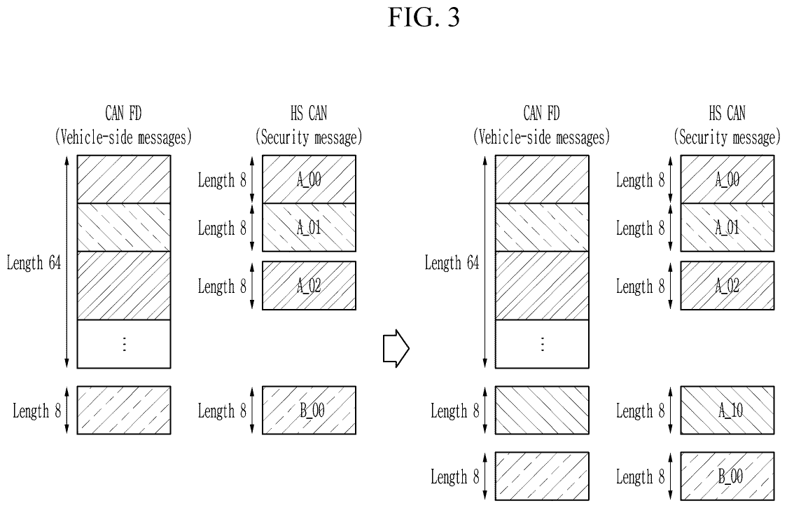

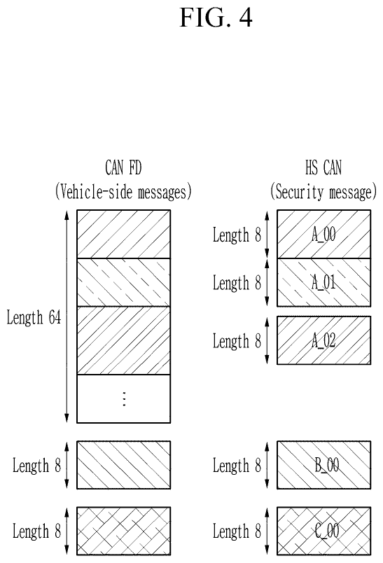

In the case of FIG. 3 and FIG. 4, the message name includes an ECU name as it is in the message name of the vehicle DB, so there is a risk that OEM vehicle controller-related information may be exposed, so an encryption of the message name is required. Depending on the communication method of the external platform, the necessary message layout must be configured by setting it to HS CAN (up to 8 bytes) or CAN FD (up to 64 bytes). Additionally, since FD and HS basically have the different message lengths, it is essential to apply consistent message naming conventions when converting them to the secure message.

For example, a message name encryption process to convert the legacy vehicle message (CAN FD) to the secure message (HS CAN) is as follows. First, the vehicle-side message is converted into the security message based on the message. For example, in FIG. 4, the first message from the top may be changed to A_00, the second message from the top to A_01, and the third message from the top to A_02. Afterwards, if another signal within the same vehicle-side message is converted into the security message due to the change or addition of the function, the last digit of A_xx may be increased. When the messages from other vehicles are converted, names may be generated by sequentially increasing the alphabet, such as B_xx, C_xx. If a new vehicle-side message is added and should be included between A_xx and B_xx in terms of priority, the name can be adjusted by increasing the first digit of A_xx.

As another example, when a new message is added between A_xx and B_xx according to the priority as shown in FIG. 3, the first digit of A_xx may be increased and adjusted like A_10.

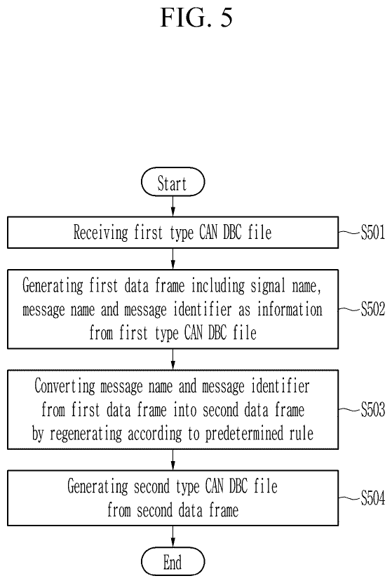

FIG. 5 is a view for explaining a file conversion method according to one embodiment.

Referring to FIG. 5, a file conversion method according to an embodiment may perform receiving a first type CAN DBC file (S501), generating a first data frame including a signal name, a message name and a message identifier as information from the first type CAN DBC file (S502), regenerating the message name and the message identifier from the first data frame according to a predetermined rule to be converted into a second data frame (S503), and generating a second type CAN DBC file from the second data frame (S504).

For more detailed information on the above method, the descriptions of other embodiments included in the present disclosure may be referred, so redundant descriptions are omitted.

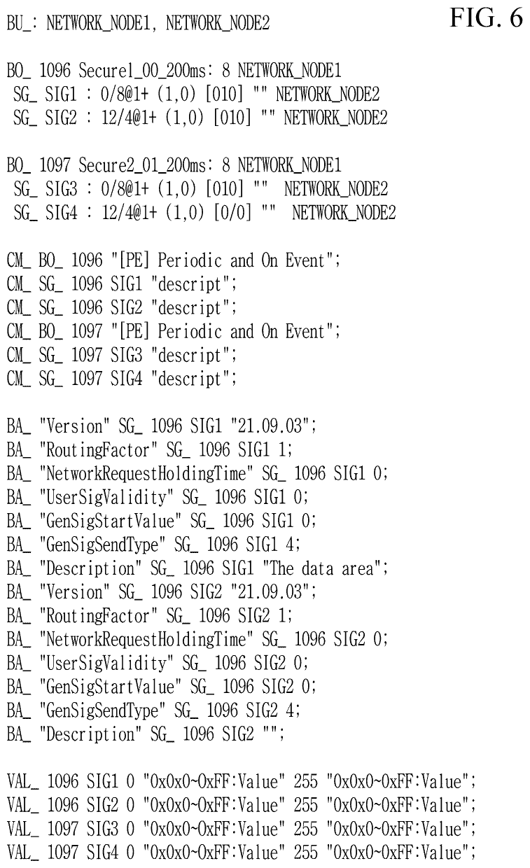

Below, the operation of the file conversion device is described with reference to FIG. 6-FIG. 14.

FIGS. 6-14 are views for explaining an operation of a file conversion device according to one embodiment.

Referring to FIG. 6-FIG. 14 together, FIG. 6 illustrates a first type CAN DBC file. The first CAN DBC files may correspond to CAN DBC files that are difficult to leak externally.

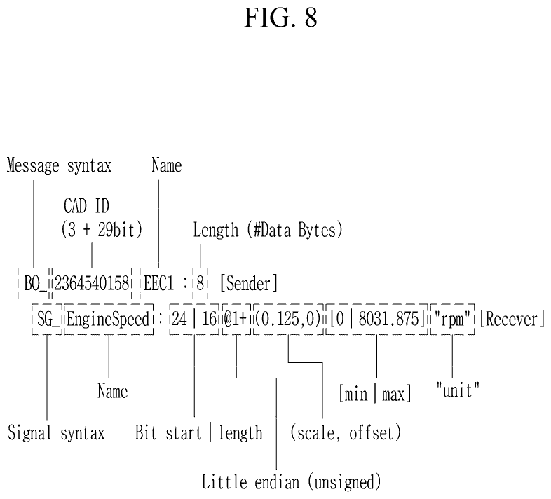

The first CAN DBC file may be a database format that defines the structure and information of the vehicle CAN data and be composed of the following sections:
1. Version and new symbols: includes information about the version of the DBC file and the symbols used, and these values are set as a default and cannot be changed.
2. Baud rate definition: defines the CAN communication data transmission speed, which is automatically allocated according to a CAN protocol.
3. Definition of network node: Provides a list of nodes included in the CAN network.
4. Definition of the message frame and signals: includes information about the message frame and signals, and the structure thereof is as shown in FIG. 8.
5. Annotation section: annotations are written in a format of CM_ SG_ (message ID) (signal name) (“description”), and a annotation target is distinguished as a node (“BU_”), a message (“BO_”), or a signal (“SG_”). The message ID is a decimal number representing the message to which the signal belongs.
6. Attribute definition part: defines basic input values and attributes of the signal in a format a BA_ (item) a SG (message ID) (signal name) (input value). The message ID is expressed in decimal.
7. Value table section: defines signal values and their descriptions in a format of a VAL_ (message ID) (signal name) (value) (“description”). The message ID expresses the ID of the message to which the signal belongs in decimal, and the value and description following the signal name represent the contents of the defined value table. This makes it clear what symbols or meanings are used for the valid values of the signal.

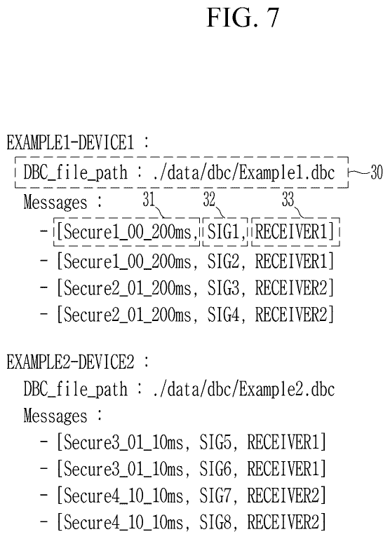

FIG. 7 illustrates the configuration file. In the configuration file, the path 30 of the first type of CAN DBC file, the message name 31, the signal name 32, and the information 33 about the receiving device may be stored in a grouped format for each of multiple CAN equipment names.

For example, the configuration file may store the path 30 of the first type CAN DBC file for the CAN device identified as “EXAMPLE-DEVICE1” as “,/data/dbc/Example1.dbc”. Additionally, the configuration file may store “Secure1_00_200ms” as the message name 31, “SIG1” as the signal name 32, and “RECEIVER1” as the information 33 about the receiving device. As illustrated, such information may be stored in the format grouped for each CAN device name.

The file conversion device 10 reads a Yaml file, for example, by utilizing a Yaml library. First, the parsing is sequentially started from the topmost signal and the information of “SIG1” is retrieved from the file called “Example1.dbc”. The file conversion device 10 sequentially reads the first type CAN DBC file “Example1.dbc” shown in FIG. 6 in one direction.

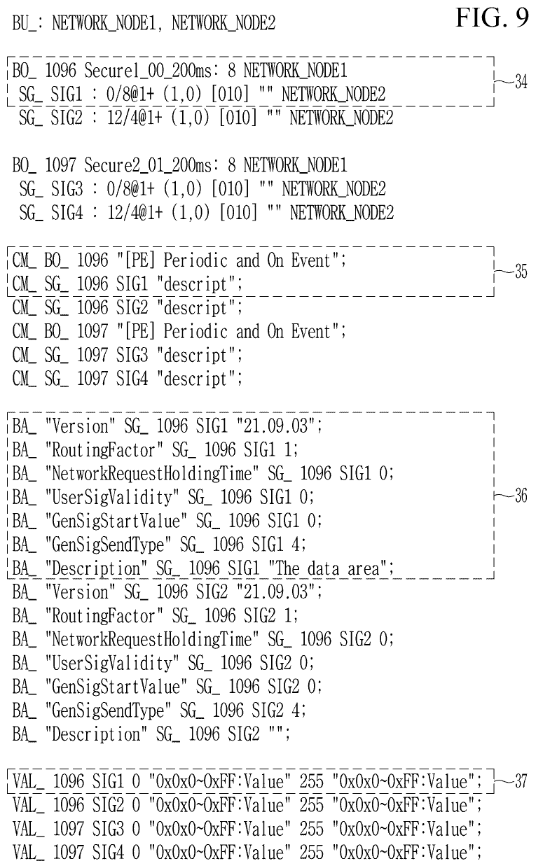

The file conversion device 10, as illustrated in FIG. 9, compares the BO_(message) 34, the SG_(signal) 34, the CM_ content) 35, the BA_ (item) 36, and the VAL_(signal value) 37 line by line with the “Secure1_00_200ms” message including “SIG1” in the first type CAN DBC file “Example1.dbc” to extract the necessary information.

Referring to FIG. 7 and FIG. 9 together, when the extraction of \“SIG1\” is completed, the file conversion device 10 compares BO_(message) 34, SG_(signal) 34, CM_ (content) 35, BA_(item) 36, and VAL_(signal value) (37) line by line to extract \“SIG2\”, \“SIG3\”, \“SIG4\”, . . . , \“SIG8\”. The information about all signals is stored in the memory as strings.

By utilizing the message frame and signal format described in the DBC illustrated in FIG. 9, the information of each signal is classified into the signal name, the start bit, the signal size, the message type, the message name, the ID, the message size, the cycle, the transmitter, the network name (Net name), the absence of the standardization application, the receiver, etc., and then stored in the form of a data frame as illustrated in FIG. 10. FIG. 10 shows the existing signal data frame.

The existing signal data frame illustrated in FIG. 10 may be converted into the secure signal data frame illustrated in FIG. 11 by modifying the signal information according to the gateway standardization design for the CAN data routing between the vehicle and an external platform. After checking whether each message is a FD (32 bytes) or a HS (8 bytes), bytes are allocated according to the protocol to be changed, and the start bit may set to 0 from the first signal within the same message based on the signal length, and the start bits may be sequentially reallocated according to the signal size. All messages may be grouped for each cycle (e.g. 10 ms, 50 ms, 100 ms, 200 ms, etc.) and new message names may be generated by assigning alphabets (A, B, C, etc.) to the messages divided for each cycle. Afterwards, all messages may be grouped for each ID, those ID are sorted in an ascending order, and they are reassigned starting from the smallest ID, such as 10, 20, 30, etc. In this way, the signal position may be changed by reallocating the start bit, and the traceability of the existing signals may be reduced by changing the message name and the ID for each cycle, thereby enhancing the message security.

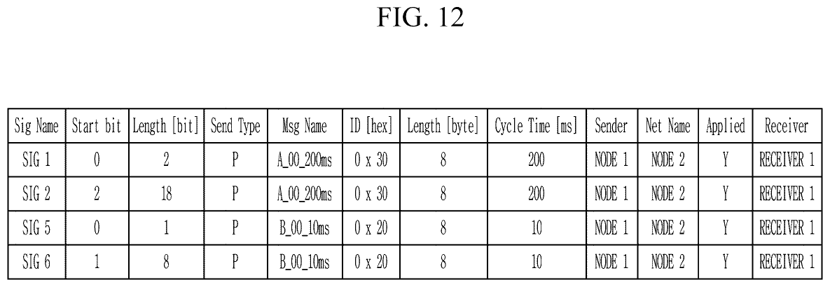

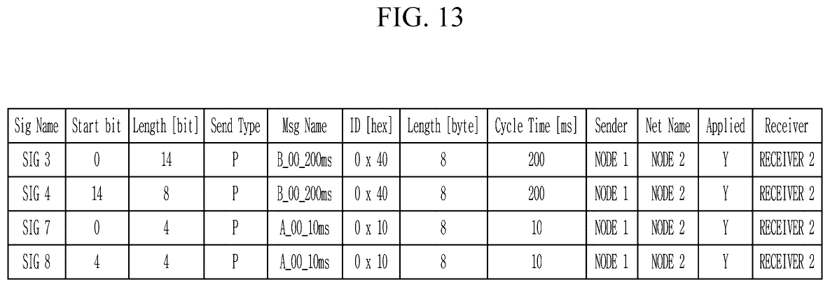

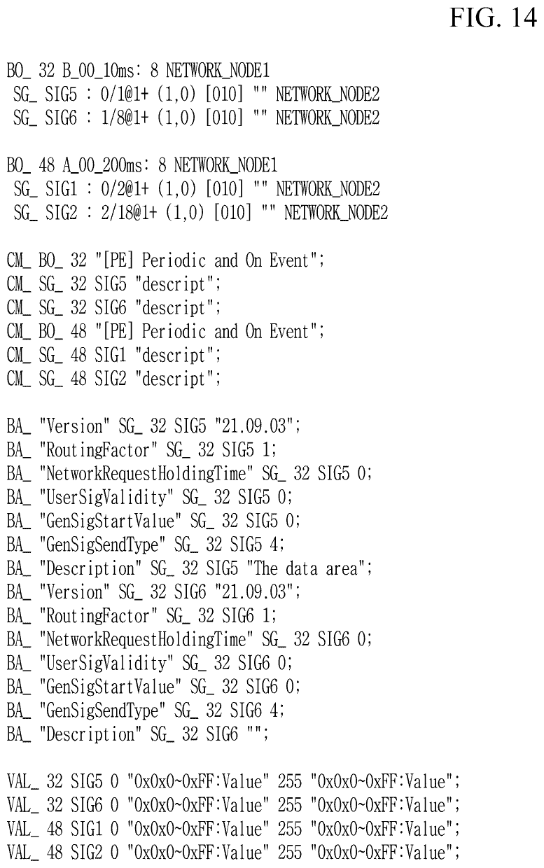

Based on the data frames processed so far, we can divide the data frames according to the receiver. In the case of FIG. 12, it may be a data frame provided to some external company, and in the case of FIG. 13, it may be a data frame provided to some other external company. And as illustrated in FIG. 14, a DBC file can be generated based on each divided data frame, and the generated DBC file can be a second type CAN DBC file.

FIG. 15 is a drawing for explaining a computing device according to one embodiment.

Referring to FIG. 15, the file conversion method and device according to the embodiments may be implemented using a computing device 50. The computing device 50 may be implemented as various types of electronic devices, servers or similar devices, and their functions may be implemented through a combination of software and hardware.

The computing device 50 may include at least one of a processor 510, a memory 530, a user interface input device 540, a user interface output device 550, and a storage device 560 communicating via a bus 520. The computing device 50 may also include a network interface 570 electrically connected to a network 40. The network interface 570 may transmit or receive signals to or from other entities via the network 40.

The processor 510 may be implemented as various types of computational units, such as an MCU (Micro Controller Unit), an AP (Application Processor), a CPU (Central Processing Unit), a GPU (Graphic Processing Unit), an NPU (Neural Processing Unit), a QPU (Quantum Processing Unit), etc. The processor 510 is a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. The processor 510 may be configured to implement various functions and methods described above with reference to FIG. 1-FIG. 14.

The memory 530 and the storage device 560 may include various forms of volatile or non-volatile storage media for storing and accessing data of the system. For example, the memory 530 may include a read-only memory (ROM) 531 and a random access memory (RAM) 532. In some embodiments, the memory 530 may be built into the processor 510, in this case, a data transfer speed between the memory 530 and the processor 510 may be very fast. In some other embodiments, the memory 530 may be located outside the processor 510, in which case the memory 530 may be connected to the processor 510 via various data buses or interfaces. This connection may be made through a variety of already known means, for example, a Peripheral Component Interconnect Express (PCIe) interface for high-speed data transfer or through a memory controller.

In some embodiments, at least some of the components or functions of the file conversion methods and devices according to the embodiments may be implemented as a program or software running on a computing device 50, and the program or software may be stored on a computer-readable recording medium or storage medium. Specifically, a computer-readable recording medium or storage medium according to an embodiment may be a computer having recorded thereon a program for causing a computer including a processor 510 that executes a program or command stored in a memory 530 or a storage device 560 to execute steps included in the implementation of a file conversion method and device according to the embodiments.

In some embodiments, at least some of the components or functions of the file conversion methods and devices according to the embodiments may be implemented using hardware or circuitry of the computing device 50 or may be implemented as separate hardware or circuitry that may be electrically connected to the computing device 50.

In some embodiments, the computing device 50 may be provided with one or more non-transitory computer-readable media including executable instructions, which, when executed by one or more processors of the computing device 50, cause the computing device 50 to perform operations. Here, the operation may include the configuration, function, steps, etc. described in the present disclosure with respect to the file conversion method and the file conversion device according to the embodiments.

According to embodiments, a library can be provided that automatically generates a gateway DBC to efficiently route CAN data between a vehicle and an external platform. Meanwhile, the library according to the embodiments may automatically generate DBC files as well as convert them into various formats upon request or need. For example, it may support converting the DBC files to other data formats, such as a CSV, so that they may be utilized on external platforms. This greatly improves a data management and a compatibility and provides a flexible data processing environment tailored to user needs.

While the present disclosure has been described in connection with what is presently considered to be practical embodiments, it should be understood that the present disclosure is not limited to the disclosed embodiments. On the contrary, it is intended to cover various modifications and equivalent arrangements included within the spirit and scope of the appended claims

What is claimed is:

1. A file conversion method performed by a computing device including a processor, the method comprising:
receiving, by the processor, a first type controller area network (CAN) database container (DBC) file;
generating, by the processor, a first data frame including a signal name, a message name, and a message identifier as information from the first type CAN DBC file;
converting, by the processor, the message name and the message identifier from the first data frame into a second data frame by regenerating the message name and the message identifier according to predetermined rules; and
generating, by the processor, a second type CAN DBC file from the second data frame.

2. The file conversion method of claim 1, wherein converting the message name and the message identifier from the first data frame into the second data frame includes:
sorting, by the processor, the message identifier in the first data frame in an ascending order; and
generating, by the processor, the message identifier as a different value in the ascending sorted state.

3. The file conversion method of claim 2, wherein generating the message identifier includes:
generating and allocating, by the processor, one message identifier for one message when the type of the message belonging to the first data frame is a High-Speed CAN (HS CAN).

4. The file conversion method of claim 2, wherein generating the message identifier includes:
generating and allocating, by the processor, a plurality of sequentially increasing message identifiers for one message when the type of the message belonging to the first data frame is a CAN with Flexible Data-Rate (CAN FD).

5. The file conversion method of claim 1, wherein:
the first data frame further includes a start bit,
converting the message name and the message identifier from the first data frame into the second data frame further includes:
generating and assigning, by the processor, the start bit to a value different from that of the first data frame.

6. The file conversion method of claim 1, wherein converting the second data frame further includes:
after the message name is generated with a different value, adding, by the processor, an identification character that is set differently for each vehicle to the generated message name.

7. The file conversion method of claim 6, wherein:
based on a message being added, a message name of the added message remains unchanged, while other values are changed.

8. The file conversion method of claim 7, wherein:
the message identifier includes alphabets and hexadecimal numbers.

9. The file conversion method of claim 1, further comprises:
transmitting, by the processor, the second type CAN DBC file to an external platform.

10. The file conversion method of claim 1, wherein generating the second type CAN DBC file includes:
generating a plurality of second type CAN DBC files by dividing the second data frame for each recipient recorded in the second data frame.

11. A file conversion device comprising:
at least one non-transitory computer-readable media configured to store instructions; and
at least one processor configured, by executing the instructions, to:
receive a first type controller area network (CAN) database container (DBC) file,
generate a first data frame including a signal name, a message name and a message identifier as information from the first type CAN DBC file,
convert the message name and the message identifier from the first data frame into a second data frame by regenerating the message name and the message identifier according to predetermined rules, and
generate a second type CAN DBC file from the second data frame.

12. The file conversion device of claim 11, wherein the at least one processor is further configured to:
sort the message identifier in the first data frame in an ascending order, and
generate the message identifier as a different value in the ascending sorted state.

13. The file conversion device of claim 12, wherein the at least one processor is further configured to:
generate and allocate one message identifier for one message when the type of the message belonging to the first data frame is a High-Speed CAN (HS CAN).

14. The file conversion device of claim 12, wherein the at least one processor is further configured to:
generate and allocate a plurality of sequentially increasing message identifiers for one message when the type of the message belonging to the first data frame is a CAN with Flexible Data-Rate (CAN FD).

15. The file conversion device of claim 11, wherein:
the first data frame further includes a start bit, and
the at least one processor is further configured to:
generate and assign the start bit to a value different from that of the first data frame.

16. The file conversion device of claim 11, wherein the at least one processor is further configured to:
after the message name is generated with a different value, add an identification character that is set differently for each vehicle to the generated message name.

17. The file conversion device of claim 16, wherein:
when a message is added, a message name of the added message remains unchanged, while other values are changed.

18. The file conversion device of claim 17, wherein:
the message identifier includes alphabets and hexadecimal numbers.

19. The file conversion device of claim 11, wherein the at least one processor is further configured to:
generate a plurality of second type CAN DBC files by dividing the second data frame for each recipient recorded in the second data frame.

20. A non-transitory computer-readable media configured to store instructions that, when executed by at least one processor of a computing device, cause the computing device to perform operations comprising:
receiving a first type controller area network (CAN) database container (DBC) file;
generating a first data frame including a signal name, a message name and a message identifier as information from the first type CAN DBC file;
converting the message name and the message identifier from the first data frame into a second data frame by regenerating the message name and the message identifier according to predetermined rules; and
generating a second type CAN DBC file from the second data frame.
